(19) United States
(12) Patent Application Publication
(10) Pub. No.: US 2025/0091675 A1
(43) Pub. Date: Mar. 20, 2025

(54) CASE FOR VEHICLES

(71) Applicant: NAD, S.L., Barcelona (ES)

(72) Inventors: Anton Maria PUIGDOMENECH FRANQUESA, Barcelona (ES); Jordi DOMENECH FONTANALS, Barcelona (ES); Pere AYALA GONZALEZ, Barcelona (ES); Jaume XICOLA SERRANO, Barcelona (ES)

(21) Appl. No.: 18/888,315

(22) Filed: Sep. 18, 2024

(30) Foreign Application Priority Data
Sep. 19, 2023 (EP) 23382946.4

(51) Int. Cl. B62J 9/20; A45C 7/00

(52) U.S. Cl. CPC B62J 9/20; A45C 7/0031

(57) ABSTRACT

The case for vehicles comprises a first casing part; and a second casing part, the first casing part being movable relative to the second casing part between an extended and a reduced position; wherein the case also comprises traction cables, which, when the first casing part is moved, cause a straight line translation of the first casing part relative to the second casing part. It allows that when a user moves the first casing part relative to the second casing part, the traction cables allow the entire first casing part to move in a straight line.

### CROSS-REFERENCE TO RELATED APPLICATION

The present application is based on and claims the benefit of European patent application Serial No. 23382946.4, filed Sep. 19, 2023, the content of which is hereby incorporated by reference in its entirety.

### OBJECT OF THE INVENTION

The present invention relates to a case for vehicles, in particular for two- or three-wheeled vehicles, the interior volume of which can be extended at the user's will.

### BACKGROUND TO THE INVENTION

It is very common to use cases on motorbikes to store the user's belongings, e.g., a helmet.

These cases are placed on the rear of the motorbike or on the side of the motorbike and comprise a base provided with a lid, which can be locked onto the base by means of a key lock to prevent unintended opening of the case by an unauthorized user.

Depending on the user's needs, he/she can choose cases of different dimensions, but usually motorbike cases have a fixed interior volume, which cannot be changed in case the user wants a larger volume on an ad hoc basis.

To solve this problem, there are already known cases that are extendable, i.e., a part of the base or lid has a flexible or telescopic portion that allows it to be extended, with the design limitations that this implies.

These variable volume cases fulfil their function of providing additional volume when required by the user but involve an additional cost for the manufacturer of such cases, as they require a mechanism to extend the additional portion of the case in a user-friendly manner.

### DESCRIPTION OF THE INVENTION

Therefore, an objective of the present invention is to provide a case for vehicles that allows changing its volume and, at the same time, it is easy to use for the user.

With the case for vehicles of the invention, the aforementioned disadvantages are solved, and there are other advantages which will be described below.

The case for vehicles according to the present invention is described in claim 1, and the dependent claims include additional features that are optional.

In particular, the case for vehicles comprises:
a first casing part; and
a second casing part,
   the first casing part being movable relative to the second casing part between an extended and a reduced position;
traction cables which, when the first casing part is moved, cause the first casing part to move in a straight line relative to the second casing part.

That is, when a user moves the first casing part relative to the second casing part, the traction cables allow the entire first casing part to move in a straight line.

This straight line is substantially horizontal in the position of use of the case when the case is used on the side of a vehicle such as a motorbike.

Thanks to this feature, the change of position from the extended position to the reduced position, or vice versa, can be carried out by pushing or pulling from any point of the movable casing of the case, the movable part not rotating on itself, i.e., maintaining a parallel displacement, and without having to make use of any additional intermediary mechanism thanks to the presence of the traction cables. As a result, the user experience is simpler and more comfortable.

Preferably, the first and second casing parts are connected to each other by means of a movable element, comprising guides.

In addition, the traction cables are mounted on the movable element.

According to a preferred embodiment, one end of each traction cable is attached to one of the guides, and the other end of each traction cable is attached to another of the guides.

Preferably, the traction cables cross each other, and according to a preferred embodiment, each traction cable comprises a first section, an inclined section and a second section, wherein the traction cables cross at a midpoint in their inclined sections.

The case for vehicles according to the present invention also preferably comprises at least one locking lever which is connected with a slider, so that actuation of the lever allows the slider to be moved.

In addition, the slider is preferably complemented by stops, the stops blocking or releasing the movement of the slider and the movable element, since the slider and the movable element are mutually interdependent.

### BRIEF DESCRIPTION OF THE DRAWINGS

For a better understanding of what has been explained above, some drawings are included in which, schematically and only by way of a non-limiting example, a practical case of embodiment is represented.

FIGS. 1 and 2 are perspective views of the case for vehicles according to the present invention, in its reduced and extended position, respectively;

FIG. 3 is a perspective view of the traction cables of the case for vehicles according to the present invention, according to a first embodiment;

FIGS. 4 to 9 are schematic views of possible different arrangements of the traction cables of the case for vehicles according to the present invention;

FIGS. 10 and 11 are perspective views of a first casing part of the case according to the present invention, in its extended position and its reduced position, respectively;

FIGS. 12 and 13 are perspective views showing the locking lever of the traction cables and its locking system, in their extended and reduced positions, respectively; and

FIGS. 14 and 15 are sectional elevation views of a part of the case according to the present invention, in its reduced and extended position, respectively.

### DESCRIPTION OF A PREFERRED EMBODIMENT

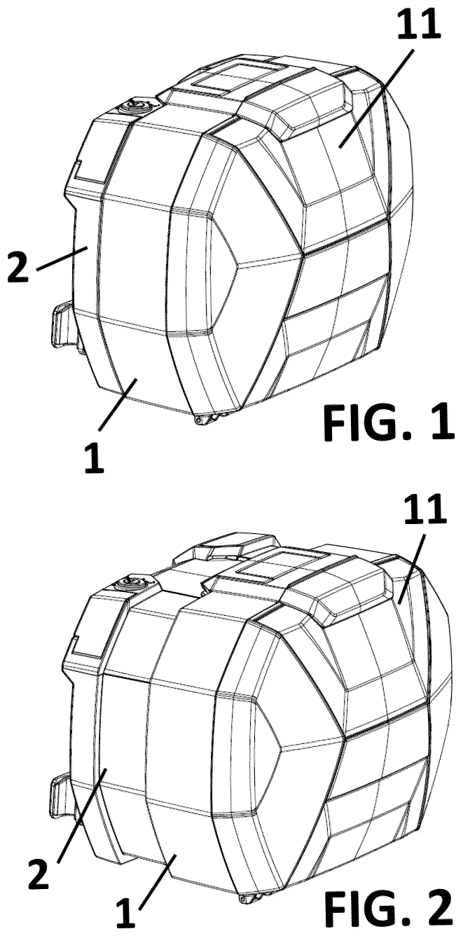

FIGS. 1 and 2 show the case for vehicles according to the present invention in its reduced and extended position, respectively.

For this purpose, the case comprises a first casing part 1 and a second casing part 2, at least one of the parts being movable relative to the other.

According to a preferred embodiment, the first casing part 1 is provided with a cover 11 and the second casing part 2 is attached to a motorbike, so that the first casing part 1 is movable relative to the second casing part 2.

Traction cables 4, 5 cause the first casing part 1 to move in a straight line with respect to the second casing part 2 when the first casing part 1 is displaced, the displacement being carried out by a user of the case.

In addition, the case also comprises a movable element 10 provided with guides 3, which connect the first and second casing parts 1, 2, as will be described below.

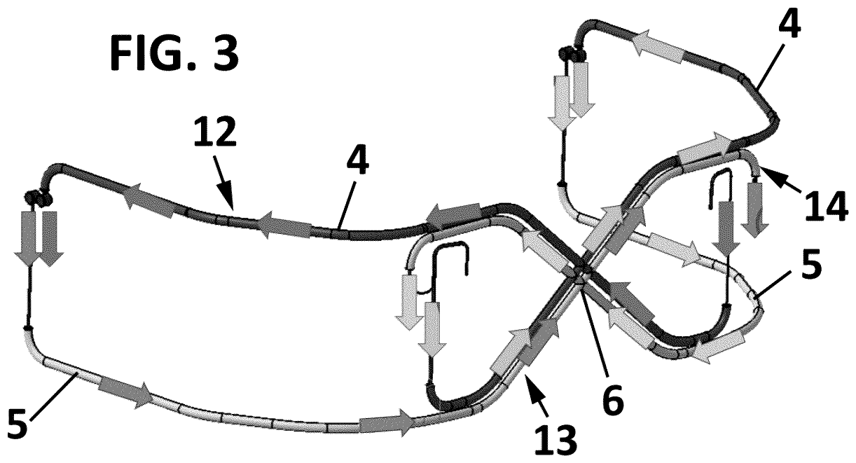

An arrangement of the traction cables 4, 5 is shown in more detail in FIG. 3. As can be seen in this figure, the traction cables 4, 5 are two pairs of traction cables.

It should be noted that the second pair of traction cables 5 is not essential, as the drive can be carried out by the first pair of traction cables 4 only, but it is preferable to use both pairs of traction cables to balance the forces exerted.

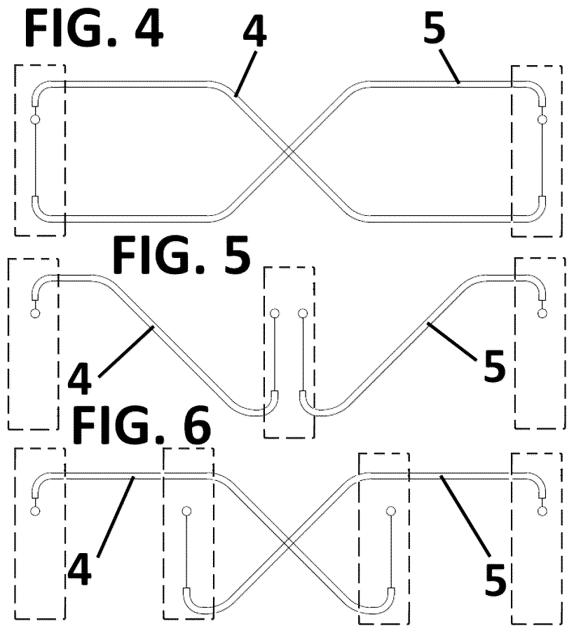

FIGS. 4 to 9 show different possible arrangements of the traction cables.

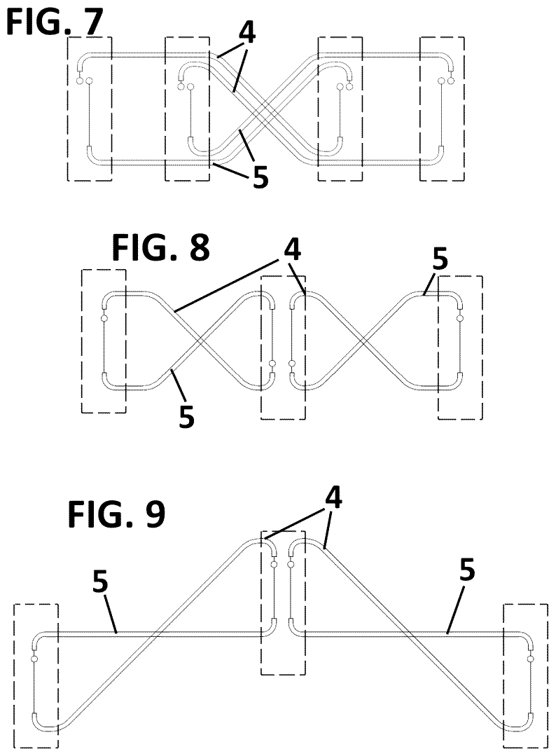

Specifically, FIG. 4 shows two traction cables crossing each other using two guides, FIG. 5 shows two traction cables crossing each other using three guides, FIG. 6 shows two traction cables crossing each other using four guides, FIG. 7 shows four traction cables crossing each other using four guides, FIG. 8 shows four traction cables in pairs, with the traction cables of each pair crossing each other using three guides, and FIG. 9 shows four traction cables in pairs, with the traction cables of each pair crossing each other in a different plane using three guides.

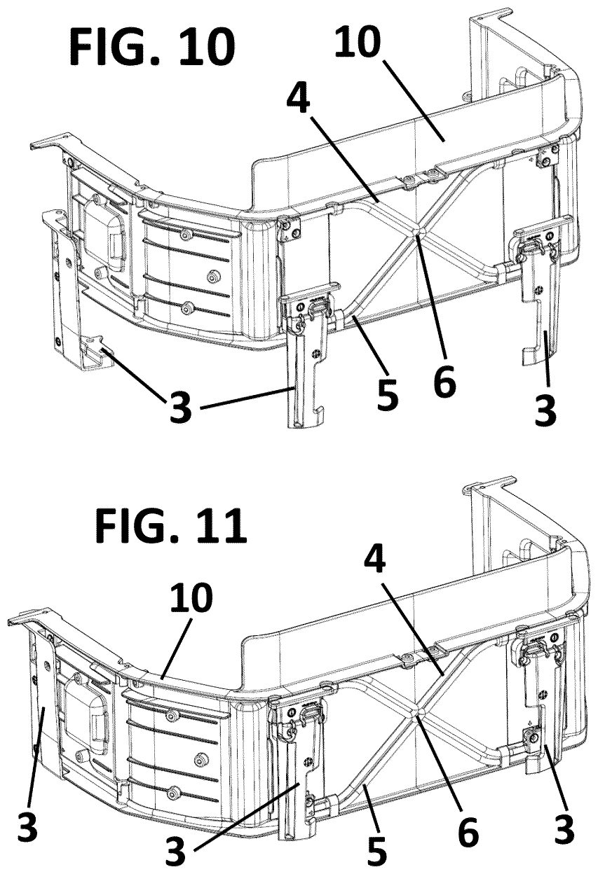

As can be seen in FIGS. 10 and 11, the traction cables 4, 5 are arranged and extend in the first casing part 1, although they could be in the second casing part 2, and the two ends of each traction cable 4, 5 are attached to the guides 3, which, in turn, each of them is interdependent with the second casing part 2, although in the event that the traction cables 4, 5 were in the second casing part 2, they would be interdependent with the first casing part 1.

In this way, the actuation of the traction cables 4, 5 causes the displacement of the first casing part 1 relative to the second casing part 2.

As can best be seen in FIG. 3, according to this embodiment, each traction cable 4, 5 comprises a first section 12, an inclined section 13 and a second section 14. In addition, all traction cables 4, 5 cross at a midpoint 6.

The traction cables 4, 5 are actuated manually from any point on the casing part 1.

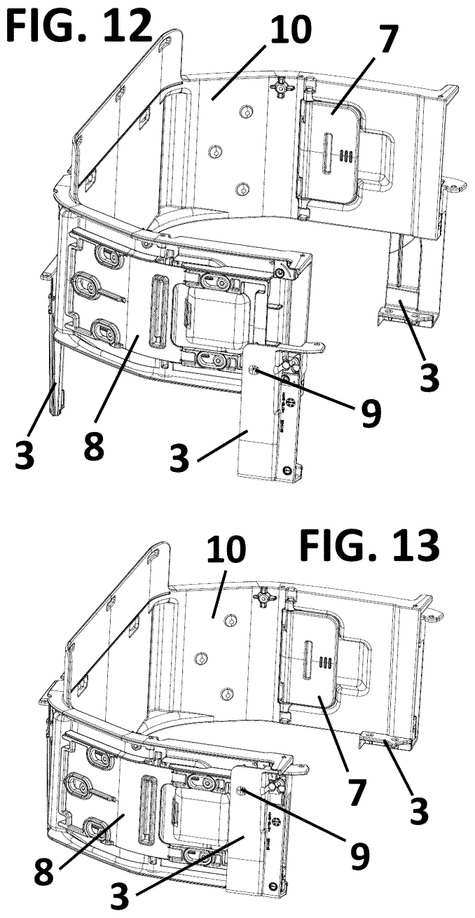

FIGS. 12 and 13 show the movable element 10, comprising locking levers 7, each connected to a slider 8, such that actuation of the locking lever 7 causes the slider 8 to move, as can be seen in FIGS. 12 and 13.

Furthermore, said slider 8 is complemented by stops 9, the stops 9 blocking or releasing the movement of the slider 8 and the movable element 10, since the slider 8 and the movable element 10 are mutually connected.

These stops 9 are movable from the locking position in the reduced position, shown in FIG. 13, to the locking position in the extended position, shown in FIG. 12, or vice versa.

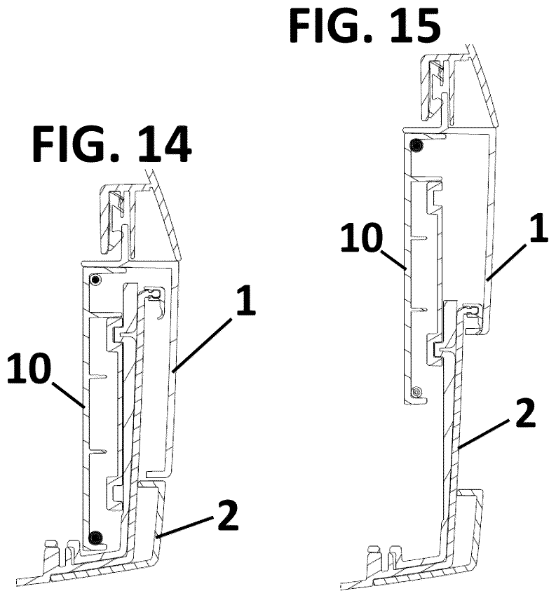

For ease of compression, the relative movement of the first and second casing parts 1, 2 and the movable element 10 is shown in FIGS. 14 and 15, in the reduced and extended position, respectively.

The operation of the case for vehicles according to the present invention is as follows. When a user wishes to expand the capacity of the case, he/she simply actuates the levers 7, for example, located on the second casing part 1 or of the movable element 10 which releases the displacement of the first casing part 1 relative to the second casing part 2, and pulls the first casing part 1.

Thanks to the presence of the traction cables 4, 5, the first casing part 1 is moved in a straight line relative to the second casing part 2. In other words, when a user moves the first casing part 1 relative to the second casing part 2, the traction cables allow the whole of the first casing part 1 to move in a straight line.

This straight line is substantially horizontal in the position of use of the case when the case is used on the side of a vehicle such as a motorbike.

In addition, to lock the case in its extended position, the user must use the same locking levers 7 to position the sliders 8 by locking the stops 9, which are also present on the second casing part 2.

Although reference has been made to a specific embodiment of the invention, it is obvious to a person skilled in the art that the case for vehicles described is susceptible to numerous variations and modifications, and that all the details mentioned can be replaced by technically equivalent ones, without departing from the scope of protection defined by the appended claims.

1. A case for vehicles, comprising:
a first casing part; and
a second casing part,
the first casing part being movable relative to the second casing part between an extended and a reduced position;
wherein the case also comprises traction cables, which, when the first casing part is moved, cause the first casing part to move in a straight line relative to the second casing part.

2. The case for vehicles according to claim 1, wherein the first and second casing parts are connected to each other by means of a movable element.

3. The case for vehicles according to claim 2, wherein the movable element comprises guides.

4. The case for vehicles according to claim 2, wherein the traction cables are mounted on the movable element or on the second casing part.

5. The case for vehicles according to claim 3, wherein one end of each traction cable is attached to one of the guides, and the other end of each traction cable is attached to another of the guides.

6. The case for vehicles according to claim 1, wherein the traction cables cross each other.

7. The case for vehicles according to claim 1, wherein each traction cable comprises a first section, an inclined section and a second section.

8. The case for vehicles according to claim 6, wherein the traction cables cross at a midpoint at their inclined sections.

9. The case for vehicles according to claim 1, comprising at least one locking lever which is connected to a slider, such that actuation of the lever allows the slider to be moved.

10. The case for vehicles according to claim 9, wherein the first and second casing parts are connected to each other by means of a movable element, and wherein said slider is complemented by stops, the stops blocking or releasing the movement of the slider and the movable element, the slider and the movable element being mutually supportive.
